(19) United States
(12) Patent Application Publication
(10) Pub. No.: US 2022/0018764 A1
(43) Pub. Date: Jan. 20, 2022

(54) METHOD FOR DETERMINING THE DISTANCE AND REFLECTIVITY OF AN OBJECT SURFACE

(71) Applicant: OSRAM GbmH, Munich (DE)

(72) Inventors: Michael Eschey, Wehringen (DE); Ricardo Ferreira, Ottobrunn (DE); Jannis Giannantonio-Tillmann, Markt Schwaben (DE)

(73) Assignee: OSRAM GmbH, Munich (DE)

(21) Appl. No.: 17/299,781

(22) PCT Filed: Nov. 20, 2019
(86) PCT No.: PCT/EP2019/081885

§ 371 Date: Jun. 3, 2021

(30) Foreign Application Priority Data
Dec. 4, 2018 (DE) 10 2018 220 932.4

(51) Int. Cl. G01N 21/47; G01S 7/481; G01S 17/06; G01S 17/931; G01S 17/894; G01S 7/4865

(52) U.S. Cl. CPC G01N 21/4738; G01S 7/4814; G01S 17/06; G01N 2201/06113; G01S 17/931; G01S 17/894; G01S 7/4865; G01S 7/4816

(57) ABSTRACT

A method for determining a distance (d) and a reflectivity of an object surface (14) using a laser source (10) that emits light (12) at a certain power and using a detector (16) that detects a level of irradiance of light (18) reflected by or scattered back from the object surface (14) and that outputs a time-dependent voltage signal on the basis thereof comprises: setting (100, 110, 220, 230, 240) the laser source (10) so that the latter emits light (12) at a specified first value of power in at least one pulse, setting (100, 110) the detector (16) so that the latter emits outputs a first voltage signal with a specified second value for a gain factor on the basis of a level of irradiance of the detected reflected or back-scattered light (18), determining (120, 260) a first value for the distance of the object surface (14) from a measured light time-of-flight (ToF) assigned to the first voltage signal, adapting (130, 150 220) the first value of the power of the laser source (10) and/or the second value of the gain factor of the detector (16) on the basis of the determined first value for the distance (d), emitting (110, 240) light (12) again using the laser source (10) and detecting the reflected or back-scattered light (18) by the detector (16) and outputting a corresponding second voltage signal using the adapted first and/or second value, determining (120, 260) a second value for the distance (d) of the object surface from a measured light time-of-flight (ToF) assigned to the second voltage signal.

### TECHNICAL FIELD

The present invention relates to a method for determining a distance of an object surface using a laser source that emits light having a power, and using a detector that detects the light reflected or backscattered from the object surface and having an irradiance and depending thereon outputs a time-dependent voltage signal. The present invention furthermore relates to the determination of the reflectivity of the object surface. Moreover, it relates to a device that carries out the method, in particular LiDAR systems.

### PRIOR ART

Such methods, which in particular are also known by the abbreviation LiDAR (Light Detection And Ranging), are based on an optical distance measurement using laser scanners. The technology has been known since the early 1970s at the latest, since LiDAR was used for measuring the topography of the surface of the moon in the orbiter modules in the context of the Apollo 15, 16 and 17 missions. The basic principle is that a laser beam is emitted in the direction of an object surface, the distance to which is to be determined, then a detector detects the reflected or backscattered light and the light time of flight (time of flight—ToF) is measured, from which in turn, given the known speed of light, the doubled path of the distance is determinable (outgoing path and return path). By means of repeated measurements, it is thereby possible to ascertain a change in distance as well, this being increasingly used in speed checks, for example.

In recent years, in particular also as a result of advances in sensor technologies, but particularly in the case of micro-opto-electromechanical components (MEMS/MOEMS) and also in the case of processor technologies, there have been strong pushes into new industrial sectors and fields of application. Mention may be made here of the traffic sector, in particular, where efforts are currently being made to enable autonomous driving, and intelligent driver assistance systems have already largely become established. LiDAR systems make it possible here to scan surroundings of the vehicles in which they are implemented, and to determine in each case distances up to moderate ranges. The results can be used to construct, in a processor-aided manner, three-dimensional images of the surroundings in which the vehicle is moving. Over and above the actual LiDAR technology, the aim here may also be to determine the reflectivity (the so-called albedo) for the object surfaces respectively measured, in order, on the basis of known values for specific materials, to obtain information about the structure and construction of the objects affected, for example the question of whether there is a tree, a road sign or an automobile etc. in the field of view.

The range is limited by the restricted sensitivity of the sensor or detector used and the power of the laser source. In order to extend the range of distance determination, the laser power could be increased, but that is at odds with stipulated safety standards for endangerment of the eye by laser beams, which standards have to be complied with; in this respect, cf. e.g. “safety of laser products—Part 1: Equipment classification and requirements”, in Technical Reports IEC 60825-1:2014 (2014). In the field of driver assistance systems and autonomous driving, moreover, the frequency range of the laser light is also kept in the near infrared (NIR) wavelength range of e.g. 840 or 900 nm to 1550 nm, and so here the human eye is unprotected owing to lack of sensitivity. The wavelength range of 840 nm to 950 nm is suitable for silicon-based applications. The range of 1100 nm to 1550 nm is suitable for III-V compound semiconductors. In the case of silicon, at the short wavelengths here the advantage of increased quantum efficiency is afforded, while the restrictions arising from the requirement of the eye safety standards in turn prove to be stricter here, however. The NIR range extends overall from 800 nm to 2500 nm. In this respect, the focus of further development is on increasing the sensitivity of the sensors, increasing the corresponding gain and improving the signal-to-noise ratio (SNR), likewise on the part of the detector.

In LiDAR applications, sensors based on avalanche photodiodes (APD) have largely become established since the latter are designed particularly for receiving and evaluating laser pulses.

This type of photodiodes represents inherently highly sensitive sensor elements which operate at high speed and which may also be regarded as a semiconductor equivalent to conventional photomultipliers. They are based on PIN diodes, but have in addition to the intrinsic i- or n-absorption layer a thin and highly doped p- or n-type layer, which generates a high electric field strength in the case of an applied reverse voltage below the breakdown voltage vis-à-vis the adjacent n⁺- or p⁺-type layer, as a result of which electric field strength the electron-hole pairs formed in the absorption layer upon absorption of a photon form charge carriers that are greatly accelerated and form further electron-hole pairs as a result of impact ionization, thus giving rise to an avalanche effect.

Multiplication factors or gain factors of from 100 to 500 can be achieved in this mode, referred to as “radiation-proportional operation”. However, this gain falls far short of that needed to detect every single photon.

The sensitivity is given by the ratio of the number of electron-hole pairs generated by absorption to the number of incident photons. It is also referred to as quantum efficiency (QE) in the case of avalanche diodes.

A very particular advantage is that there is a proportional relationship between the number of incident photons and the sensor response, i.e. the output voltage is proportional to the corresponding radiation power. This makes it possible, in the case where APDs are used, on the basis of the distance known from the time of flight determination (i.e. with local irradiance being known), for the reflectivity of the respectively relevant object surface to be deduced directly proceeding from the voltage signal output by the sensor.

While APDs thus offer a high sensitivity and the advantage of proportional behavior of the output voltage vis-à-vis the radiation power with a fast response, that is offset by only inadequate gain and not inconsiderable thermal noise and shot noise.

Specially configured avalanche photodiodes can expediently also be operated above the breakdown voltage. This operation is also referred to as the Geiger mode and the relevant photodiodes are called single-photon avalanche diodes (single-photon avalanche diode, for short: SPAD). On account of the then very high field strengths in the multiplication zone, great accelerations are achieved and as a result 10⁶ to 10⁸ electron-hole pairs are generated on the basis of just one photon, i.e. the gain can be more than 10⁶, and it becomes possible to detect single photons. In order to prevent a situation in which, after an avalanche has been generated, the photodiode remains conductive on account of the high currents and is thus no longer available at all for further detection of photons, the SPAD diode can be provided with a series resistance and a suitably interconnected capacitance. After the breakdown of a charge carrier avalanche, a partial voltage is dropped across the series resistance, such that the reverse voltage across the diode falls below the breakdown voltage. This process is referred to as quenching. In the meantime, the voltage across the diode becomes charged again, and so after a dead time it is available again for a further avalanche in a cyclic manner. On account of said dead time, however, the single SPAD diode is unsuitable for use as a LiDAR detector, since once again not all of the photons can be detected.

This can be achieved, however, by a combination of large numbers of SPAD diodes respectively configured in microcells to form a so-called silicon photomultiplier (SiPM), wherein the SPAD diodes, each of which is operated in the Geiger mode, including their series resistances are interconnected in parallel with one another. Consequently, the photons impinging on the individual microcells each bring about avalanche-like output pulses, which in their entirety are statistically superposed to form an n-fold stronger voltage signal output by the SiPM sensor, wherein the number n corresponds to the number of microcells in the SiPM array and, given cell sizes of e.g. 10 μm to 100 μm and total dimensions of the SiPM sensor of 1×1 mm², can comprise up to 10 000 microcells.

In this respect, SiPM-based detectors afford the advantage of a sufficiently high gain and moreover also comparatively low noise or a satisfactory signal-to-noise ratio for measured voltage signals.

Unfortunately, however, that is in turn offset by lower sensitivity and a dynamic region restricted by a nonlinear saturation region of the output voltage for high radiation powers in the case where SiPM sensors are used. For SiPM sensors the sensitivity is defined by the photon detection efficiency (PDE), which is a product of the quantum efficiency, an avalanche initiation probability and the fill factor. The fill factor indicates that proportion of the total area of the microcell which is constituted by the active area respectively available for photon detection. The more cells are included, i.e. the smaller the cell size for a given total area of the SiPM sensor, the lower the fill factor (e.g. more peripheral area) and hence the sensitivity. On the other hand, increasing the number n of cells results in an expansion of the dynamic region, i.e. that voltage interval of the output voltage which is available for a use and ideally yields the proportionality between radiation power and output voltage.

If the radiation power is excessively high, the relationship between a respective voltage amplitude as pulse response to the laser pulse and the pulse power in the case of SiPM sensors transitions to a nonlinear saturation region in which increasingly all the microcells are in a state of immediate photon detection after resetting by means of quenching and the dead time possibly following on cyclically. Consequently, it is always necessary to find a difficult compromise between the expansion of the dynamic region by the use of sensors having more cells and the improved sensitivity by the use of fewer but in return larger cells (given a fixed total area). This is because in the case of more cells given a predefined total area, they have an ever-decreasing cell size, such that design limits are rapidly encountered and at the same time the photon detection efficiency (PDE) decreases rapidly.

In any case the limitation of the dynamic region at a detector directly also restricts the distance range within which light signals can still be reliably detected for the distance determination and can also be evaluated with regard to ascertaining the reflectivity.

### SUMMARY OF THE INVENTION

It is therefore an object of the invention to provide a method of the generic type for determining a distance of an object surface and a corresponding device in which a distance range within which light signals can still be reliably detected for the distance determination and can also be evaluated with regard to ascertaining the reflectivity is extended further.

The object is achieved by means of a method for determining a distance of an object surface having the features of patent claim 1 and by means of a corresponding device having the features of claim 15. The dependent claims relate to advantageous developments of the method according to the invention.

A method having substantially two stages is proposed here. The starting point is a method for determining a distance of an object surface, wherein use is made of a laser source that emits light having a power and a detector that detects the light reflected or backscattered from the object surface, said light arriving in the detector with an irradiance, and depending thereon outputs a time-dependent voltage signal. The detector can preferably be an SiPM sensor, or a sensor having similar properties.

Firstly, for each individual distance determination (that is to say repeatedly at high frequency for the individual pixels in the case where the surroundings are scanned by laser scanning), one or both of the two following steps is or are carried out: the laser source is set such that the latter emits light having a predetermined first value of the power in at least one pulse, and/or the detector is set, such that the latter outputs a first voltage signal having a predetermined second value for a gain factor or the gain depending on the irradiance of the reflected or backscattered light detected. The gain factor or the gain is usually set by way of the overvoltage at the detector. Here there is a generally linear relationship between the stated variables. The overvoltage is equal to the difference between the (set) reverse voltage and the respectively usable and moreover temperature-dependent breakdown voltage. The setting of the gain factor or gain is thus synonymous with the setting of the overvoltage or reverse voltage. Likewise, the setting of the power or radiation power of the laser source usually corresponds to the setting of a driver voltage (also called: drive voltage).

In a further step, a first absolute value for the distance of the object surface is determined from a measured light time of flight (ToF) assigned to the first voltage signal. In this case, it is regularly assumed that laser source and detector are substantially almost positionally identical, i.e. are at a negligible distance from one another in comparison with the distance to be measured. This holds true in particular for a possible mutual offset in the direction of the object surface. If such an offset is nevertheless present, it can correspondingly be taken into account as well in the detection and calculation of the distance from the light time of flight (ToF).

In a further step, the first value of the power of the laser source and/or the second value of the gain factor or gain of the detector are/is adapted depending on the first absolute value for the distance determined from the time of flight measurement. In this case, the adaptation can be effected in particular such that the irradiance in the detector falls within the dynamic region thereof, that is to say that, firstly, a voltage signal having a usable amplitude is actually generated in the first place by means of the adaptation and, secondly, the amplitude falls within a voltage range in which—with the distance known—the information linked with the amplitude can be evaluated further, in particular for the calculation of the reflectivity of the affected object surface. In the dynamic region there is, in a targeted manner, a substantially linear one-to-one relationship between the amplitude of the voltage signal and the irradiance (which for a given distance correlates with the radiation power of the laser source).

In contrast to the dynamic region there is a nonlinear transition region toward a saturated region in which, if the radiation power or irradiance is too high or the gain factor set is too great or the overvoltage set is too great, the amplitude response of the detector asymptotically approaches a maximum value of the voltage, i.e. the amplitude then no longer scales with the irradiance and it would then be virtually impossible to calculate for example the reflectivity, etc.

It should be noted that an amplitude-dependent time offset (or time shift or time walk) occurs in the dynamic region of the detector in the case of SiPM sensors: the smaller the amplitude, the later amplitude response is output. This phenomenon does not occur in the case of APD sensors. The result would be inherently a systematic error in the distance determination toward smaller amplitudes or irradiances. According to one aspect of the invention, this effect can be taken into account by a calibration of the detector.

In a subsequent step, on the basis of the newly adapted first and/or second values of the radiation power and/or the gain factor, once again light is emitted by the laser source in a pulsed manner and the reflected or backscattered light is detected by the detector. Accordingly, a second voltage signal is output by the detector.

Optionally, the light time of flight can be repeatedly ascertained from said second voltage signal and a second absolute value for the distance of the object surface can in turn be determined from said light time of flight. This optional second absolute value or else already the first absolute value is finally output as the measured distance. A further iteration is then regularly no longer necessary. The first absolute value may possibly already have been determined sufficiently accurately or near to the actual value. What is important is that the voltage signal for a subsequent albedo determination is present with sufficient quality, i.e. with an amplitude in the dynamic region, to be described below, which enables a corresponding evaluation.

The adaptation—proposed according to the invention—of the radiation power and/or of the gain factor for example such that the detector can detect the incident radiation as much as possible in the dynamic region enables the distance range that is to be measured, namely including an albedo determination, to be extended both toward shorter distances and toward greater distances. In the case of shorter distances, a reduction of the radiation power can draw the irradiance of the material-dependently reflected or backscattered light from the saturated region of the detector into the dynamic region.

In the case of greater distances, particularly if the radiation power of the laser source is already at the upper limit defined by safety standards, the gain or the overvoltage of the detector can also be increased if an e.g. SiPM sensor is used for this purpose. However, in this case there is also an increase in effects of so-called afterpulsing (within microcells) and of optical crosstalk (between adjacent microcells) with this type of sensors (decreasing signal-to-noise ratio), such that in this case the dynamic region becomes somewhat narrower if the gain is chosen to be excessively high, such that the distance range cannot be extended arbitrarily. Precisely in the field of autonomous driving and driver assistance systems, however, the invention enables an extension of the distance range while maintaining albedo measurements of up to 300 m or more.

According to one development of the method according to the invention, the detector includes a silicon photomultiplier, i.e. an SiPM sensor. A laser that operates in the near infrared spectral range, preferably in the range of wavelengths of 900 nm to 1550 nm, is suitable as laser source. Other wavelength ranges are not ruled out, however, particularly in the visual range of 350 nm to 900 nm. This applies to the laser source and also to the SiPM sensor, which of course have to be coordinated with one another.

According to a further development of the method according to the invention, the steps of the method are carried out repeatedly for individual pixels in the context of a LiDAR application in the field of driver assistance systems or systems for autonomous driving for scanning surroundings of a vehicle for the computer-aided construction of a three-dimensional image of the surroundings. The effects achieved by the invention have a particularly advantageous outcome in this field of application.

According to a further development of the method according to the invention, a first, upper voltage limit value for a voltage is predefined, wherein for voltages below the limit value for the detector there is a substantially linear relationship between the irradiance of the incident light and a voltage output as a consequence thereof, and above said limit value the relationship is nonlinear and/or saturated. This voltage limit value thus defines as it were the upper limit of the dynamic region.

Furthermore, an amplitude of the first voltage signal is determined and is compared with the voltage limit value, that is to say that the fact of whether or not the specific first voltage signal lies in the dynamic region is determined. In the subsequent step of adapting the first value of the power of the laser source and/or the second value of the gain factor of the detector, the extent of this adaptation is then carried out depending on the result of the comparison.

According to a refinement of this aspect, the adaptation includes in particular a decrease of the first and/or second value if the amplitude exceeds the voltage limit value, such that in the subsequent step the irradiance of the incident light is reduced in the detector and as a consequence thereof an amplitude of the second voltage signal falls below the predefined first voltage limit value. Advantageously, the dynamic region of the detector is employed again under these circumstances.

According to a further refinement of this aspect, the decrease includes a reduction of the first and/or second value by 40% or more, preferably 50% or more, and/or else by 60% or less. This decrease by e.g. 40-60% ensures that the amplitude response of the second voltage signal that is obtained in the second pass falls approximately in the center of the dynamic region.

According to a further development of the method according to the invention, a second, lower voltage limit value is predefined for a voltage, which value ensures a predefined signal-to-noise ratio, for example 2 dB or more, preferably approximately at least 10 dB, for the detector. Said second, lower voltage limit value defines the lower limit of the dynamic region. In further steps (in a manner similar to that above) an amplitude of the first output signal is determined and is compared with the second voltage limit value. In this case, the step of adapting the first value of the power of the laser source and/or the second value of the gain factor of the detector includes an increase of the first and/or second value, such that in the subsequent step the irradiance of the incident light is reduced in the detector and as a consequence thereof an amplitude of the second voltage signal lies above the predefined second voltage limit value. Analogously to the procedure described above, the increase can be effected here e.g. such that 40 to 60% of the saturation value (known in advance) of the output voltage of the detector is obtained after the adaptation, that is to say that the amplitude response in the case of the second voltage signal subsequently in the second pass lies in the center of the dynamic region here, too.

The following aspects are directed in particular to an albedo determination carried out after a distance value (first or second value for the distance) has been obtained, i.e. the determination of the reflectivity of the object surface respectively scanned.

According to a further development of the method according to the invention, provision is made of a function between the power of the laser and the distance of the object surface for a fixedly selected irradiance of the detector in relation to the reflected and/or backscattered light. The first value of the power predetermined for the adaptation and/or the predetermined second value for the gain factor are/is ascertained with the argument of the first absolute value for the distance determined from the first voltage signal by way of this function and the adaptation is carried out according to this function. The fixedly selected irradiance advantageously lies e.g. in the dynamic, i.e. substantially linear, region of the detector, preferably in the center thereof (e.g. 40-60% of the value of the output voltage at which the latter is saturated). The laser power and the distance are then assigned to one another one-to-one in order that the condition of a constant irradiance is met. The function provided forms as it were a guide for the adaptation in the second pass (i.e. adaptation of the parameters power and/or gain and generation of the second voltage signal) and ensures that the dynamic region of the detector is complied with, such that the albedo determination subsequently becomes possible.

According to a further development of the preceding aspect, before the step of the first setting of the power of the laser and/or the gain factor of the detector, a start value for the absolute value of the distance is predefined. Then in a subsequent step, the power and/or the gain factor are/is ascertained from the predefined function, on the basis of which the laser source and/or the detector can subsequently be set. By virtue of this step, in the method sequence from the outset it is possible to employ the predefined function which relates the parameter space of the settable values (power, gain) and the result (distances) obtained therefrom while complying with a condition (irradiance in the dynamic region or amplitude response in the output signal of the detector) and thus allows the cyclic passes of the method steps.

According to a further development of the preceding aspects, a lower power limit and an upper power limit are defined for the predefined function between the power of the laser and the distance of the object surface, wherein for all distances below the distance assigned to the lower power limit, only the value of the lower power limit is returned and used, and for all distances above the distance assigned to the upper power limit, only the value of the upper power limit is returned and used. This ensures that operation is effected only in the permissible power range of the laser source.

According to a further development of the preceding aspects, for example, the lower power limit is set in accordance with a minimum output power of the laser source. Likewise, the upper power limit can be set in accordance with a safety standard of the laser source.

According to a further development of the method according to the invention, then after the step of determining the second absolute value for the distance of the object surface from a measured light time of flight assigned to the second voltage signal, a further step of determining the reflectivity of the object surface on the basis of the second voltage signal and the determined second value for the distance can be carried out. This corresponds e.g. to the albedo determination itself. It is alternatively also possible to use the second voltage signal and alternatively already the first absolute value for the distance in this albedo determination. As mentioned above, by virtue of this step, the preparatory features making this possible manifest the full advantageous effect. According to an advantageous modification or supplementation of this aspect, provision is made for providing the albedo determination in each pass, i.e. also already after determining the first value for the distance out of the first voltage signal.

According to a further development of the preceding aspect, a second function is provided, which indicates a linearized response y_{act} to an amplitude of the second voltage signal, having the form:

y_{act}=x=−log(1−amp/c1)·c1/c2, (1)

wherein x corresponds to the radiation power of the laser source or a driver voltage thereof and amp corresponds to the amplitude of in each case the first or second voltage signal, and c1, c2 are coefficients determined from measurements by means of a mathematical fit. In this case, the coefficients are specific to the detector used and may differ significantly from detector to detector. However, it is applicable to SiPM sensors, in particular, and takes account of a saturation region present. The variable y_{act} corresponds to a voltage (e.g. measured in volts) or a power (e.g. measured in watts).

Furthermore, a third function is provided, which indicates a linearized reference variable y_{ref} as a function of a distance of the object surface and a power of the laser source, having the form:

y_{ref}=α(d)·x, (2)

wherein x corresponds to the power of the laser source or a driver voltage thereof and a is a linear gradient factor with which a reference power as linearized reference variable and the radiation power are linked with one another and which depends on the respective distance d of the object surface. For a given distance and a given detector and optical parameters (laser and optical system), α(d) is a fixedly predefined value.

In this case, the linearized response y_{act} is calculated from the amplitude of the second voltage signal determined by measurement. The linearized reference variable y_{ref} can be calculated from the ascertained second value for the distance and the power of the laser source. The reflectivity is finally calculated from a quotient of the linearized response y_{act} and the linearized reference variable y_{ref}, in particular e.g. from a square root of the quotient.

According to one particular embodiment, the linearized reference response y_{ref} is calculated from:

y_{ref}exp(k1·log(d)2+k2·log(d)+k3)·x (3)

wherein x corresponds to the power of the laser source and d corresponds to the distance of the object surface, and k1, k2 and k3 are coefficients determined from measurements by means of a mathematical fit.

A device according to the invention for determining a distance of an object surface comprises for example a laser source that emits light having a power, a detector that detects the light reflected or backscattered from the object surface and having an irradiance and depending thereon outputs a time-dependent voltage signal, and a control device. The latter is configured to carry out the method having the steps in accordance with the explanations above. The same advantages as mentioned above are afforded here.

Further advantages, features and details of the invention are evident from the claims, the following description of preferred embodiments, and with reference to the drawings. In the figures, identical reference signs designate identical features and functions.

### BRIEF DESCRIPTION OF THE DRAWING(S)

In the figures:

FIG. 1 shows a schematic block diagram of a device for determining a distance of an object surface which can be used to implement an exemplary embodiment of the method according to the invention;

FIG. 2 shows a schematic block diagram of a more specific device for determining a distance of an object surface which can be used to implement an exemplary embodiment of the method according to the invention;

FIG. 3 shows a block circuit diagram of an SiPM sensor;

FIG. 4 shows an equivalent circuit diagram of an SPAD microcell of an SiPM sensor;

FIG. 5 shows a diagram with a current-voltage characteristic curve of the microcell from FIG. 4 and a schematic illustration of the cyclic pass through the corresponding operating modes or phases;

FIG. 6 shows a schematic diagram illustrating the measurement of the light time of flight, wherein the strength of a signal Sn (e.g. voltage) of the pulse or the pulse response is plotted against time;

FIG. 7 shows a schematic comparison of the signal-to-noise ratio (SNR) plotted against the distance for SiPM and APD sensors;

FIG. 8 shows a schematic comparison of the pulse responses plotted against time between SiPM and APD sensors for six different power levels of the output signal in the laser source, the pulse responses between the sensor types being intentionally time-shifted relative to one another for the comparison;

FIG. 9 shows in a schematic diagram analogously to FIG. 6 for an SiPM sensor the boundary conditions to be complied with by means of laser safety standards, the laser power serving as a settable parameter;

FIG. 10 shows in a schematic diagram analogously to FIG. 6 for an SiPM sensor the boundary conditions to be complied with by means of laser safety standards, the gain factor or gain serving as a settable parameter;

FIG. 11 shows in a flow diagram the schematic sequence of the method in accordance with the first exemplary embodiment;

FIG. 12 shows in a diagram for an SiPM sensor the relationship between the amplitude amp of a voltage signal respectively output and the overvoltage V_{OV} of the detector or a variable x derived from the driver voltage of the laser source with a linear relationship;

FIG. 13 shows in a diagram the logarithm of the linear gradient, log(α), of the amplitude of the voltage signal relative to the overvoltage/driver voltage as a function of log (d), wherein d is the distance from laser source and detector, for the calculation of the reflectivity of the surface portion in accordance with the second exemplary embodiment;

FIG. 14 shows in a diagram a function V1 (d), which simplifies the calculation of the distance and represents the driver voltage of the laser source as a function of the distance d, wherein between d₀ₘᵢₙ and d₀ₘₐₓ, by means of adaptation of the driver voltage V1 of the laser source, an irradiance in the detector, independently of the distance d, is always maintained approximately in the center of the dynamic region;

FIG. 15 shows in a diagram the irradiance Ir as a function of the distance d, wherein the target value in the center of the dynamic region lies between SiPM-MAX and SiPM-MIN and is 100 μW/m², as long as the distance d falls between d₀ₘᵢₙ and d₀ₘₐₓ;

FIG. 16 shows in a flow diagram the sequence of the method in accordance with a third exemplary embodiment.

### PREFERRED EMBODIMENT(S) OF THE INVENTION

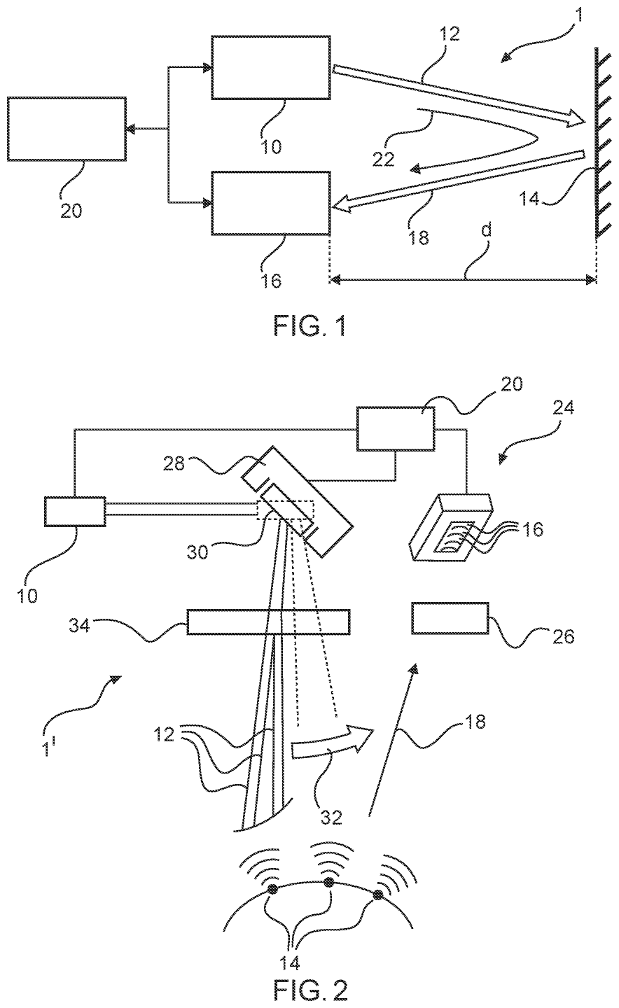

FIG. 1 shows, on the basis of a schematic block diagram, a device 1 for determining a distance of an object surface which can be used to implement an exemplary embodiment of the method according to the invention. It shows the basic set-up of a LiDAR device for distance determination by means of time of flight (ToF) measurement. A laser source 10 emits high-frequency pulses of monochromatic and coherent and sharply focused light 12 in the direction of an object surface 14, which reflects and/or backscatters said light. A detector 16 receives or detects the reflected and/or backscattered light 18. A central control device 20 (regularly an IC chip) of the device 1 is connected to the laser source 10 and the detector 16 via electronic lines with corresponding interfaces and coordinates the process of pulse generation and detection. In particular, the control device 20 can assign the relevant pulse signals and record the point in time in each case of the relevant pulse generation in the laser source 10 and the resultant pulse detection in the detector 16 and calculate the light time of flight 22 from the difference. With the speed of light being known, the distance d to the object surface 14 can immediately be determined therefrom (or from half the light time of flight, taking account of the outgoing path and return path).

In the exemplary embodiment of a device 1 as shown in FIG. 1, the detector 16 is a silicon photomultiplier (SiPM). The latter is distinguished by a low signal-to-noise ratio (SNR) and a high gain factor (gain), which moreover is linearly settable with the aid of the control device 20 by way of the control of the overvoltage, to be explained below. Likewise, the control device 20 can set inter alia the power of the laser radiation by way of the driver voltage of the laser source (just as, however, pulse duration and frequency and further parameters can also be set). The laser source 10 can comprise further optical elements—not shown here—such as lenses, diffusers, shutters, filters and mirrors, etc. The detector can likewise comprise further optical elements, in particular lenses, etc.

FIG. 2 shows a further, more specific exemplary embodiment of a device 1′, wherein the control device 20 is configured to carry out the steps of the below-described first exemplary embodiment of a method according to the invention. Identical reference signs designate features identical or similar to those in the first exemplary embodiment, a repetition of the detailed description being dispensed with.

The device 1′ concerns a LiDAR system for use in vehicles in order to support an ADAS system (advanced driver-assistance system), i.e. a driver assistance system. Here it is necessary not just simply to carry out a distance determination, but to generate a three-dimensional image of the complete or partial surroundings of the vehicle (not shown) in which the device is fitted, for example in order to evaluate obstacles or signs fitted in a stationary fashion, etc. The laser source 10 here comprises a laser diode that emits light 12 in a beam (as described above) in the near infrared (NIR) wavelength range (900 nm to 1550 nm). In order to scan the surroundings, a microelectromechanical component 28 (MEMS) having one or more micromirrors 30 adjustable at high frequency is provided, which micromirrors can deflect the light beam in a manner rotating or oscillating at high frequency about an individual axis under the control of the control device 20. The deflected laser beam (light 12) is guided through a diffuser 34, which expands the beam in a vertical direction (in the schematic illustration in FIG. 2 perpendicularly to the plane of the drawing and therefore only schematically indicated), such that the expanded beam of the light 12 is guided over the surroundings in a horizontal deflection direction 32. In the process its cross section sweeps over the respective surfaces 14, which reflect or backscatter the light substantially depending on the material and the surface constitution. In this case, the pulses of the laser diode are synchronized with the micromirror(s) 30.

Part of the backscattered or reflected light 18 passes through a lens optical unit 26, which focusses the light onto a photodiode array 24, which comprises detectors 16 embodied as SiPM sensors in this exemplary embodiment, too, which are arranged vertically in series. The number of detectors 16 is chosen in accordance with the expansion of the beam (light 12). The detectors detect the light 18 assigned to them via the optical unit, from which, with application of the method, the control device 20 ascertains for each pixel a distance d and a value for the albedo (reflectivity). The pixels are defined in a vertical direction by the detectors 16 arranged in series in the photodiode array 24, and in a horizontal direction by discrete angular positions of the micromirror(s) for the relevant pulses. The image finally constituted can have a resolution of e.g. 256×84 pixels, or 0.25°×0.3° given an image field of 60° horizontally and 20° vertically. The ranges are more than 200 m for detecting pedestrians or more than 300 m for detecting other vehicles. The values indicated are merely by way of example and on no account restrict the scope of protection defined by the claims.

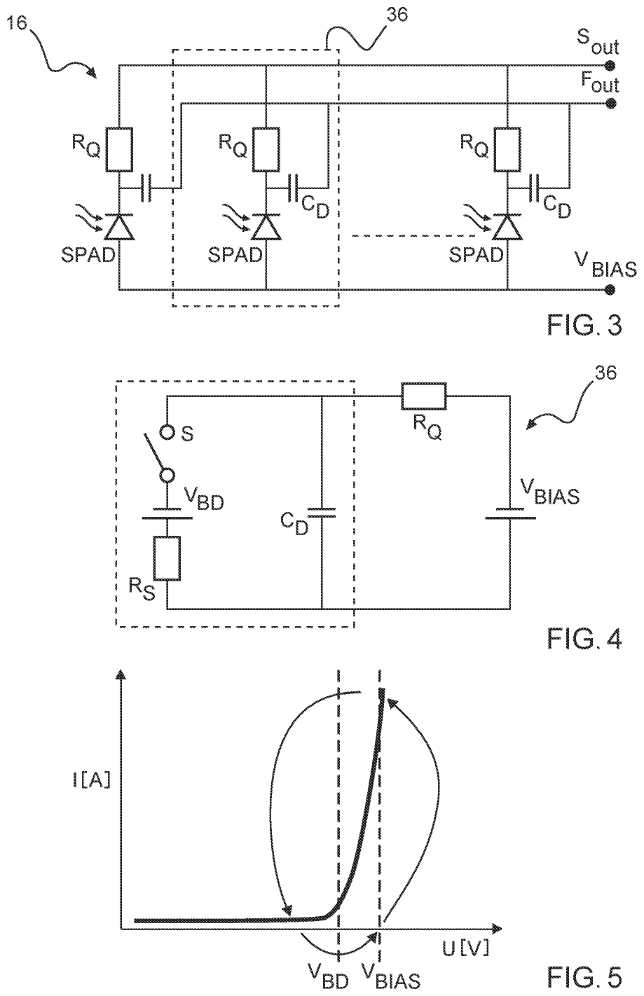

FIGS. 3 to 5 illustrate the function of the detector 16 embodied as an SiPM sensor such as is used for example in the devices 1, 1′ in FIG. 1 or 2. The subject matter of these three figures constitutes useful background knowledge. A more detailed explanation in this respect can also be found in “Introduction to silicon photomultipliers (SiPMs)”, White Paper by First Sensor, Version 03-12-15, downloaded from https://www.first -sensor.com/en/products/optical-sensors/detectors/silicon -photomultipliers-sipms/ on Nov. 7, 2018. FIG. 3 shows a block circuit diagram of such an SiPM sensor. In each microcell 36, an avalanche photodiode (APD), which here is operated in the Geiger mode, between the anode terminal (at V_{BIAS}) and the cathode terminal (at S_{OUT}) is connected in series with a quench resistance R_{Q}. The avalanche photodiode operated in the Geiger mode is also referred to as SPAD (single photon avalanche diode). This series connection of each cell is in turn connected in parallel throughout among one another, that is to say that the avalanche-generated current and voltage pulses of all the microcells 36 are superposed in the same way at the output of the circuit of the detector 16. C_{D} denotes a diode capacitance respectively present.

FIG. 4 shows an equivalent circuit diagram of an SPAD microcell 36 of an SiPM sensor. In this case, the SPAD diode is formed from a switch S arranged in series, a voltage source V_{BD} and a series resistance R_{S} of the semiconductor substrate formed e.g. from silicon. The diode capacitance C_{D} is connected in parallel therewith. As is shown in FIG. 3, therewith externally the quench resistance R_{Q} is connected in series vis-à-vis the terminals of the voltage source V_{BIAS}. In this case, the quench resistance R_{Q} is much greater than the series resistance R_{S}. During operation, in a first phase, which is referred to as quiescent mode and in which no photons are incident in the active region of the microcell 36, the reverse voltage V_{BIAS} is applied or built up with regard to the diode capacitance C_{D}. Since the cell is operated in the Geiger mode, V_{BIAS} is above the breakdown voltage V_{BD}. The difference between the reverse voltage V_{BIAS} and the breakdown voltage V_{BD} is referred to as overvoltage V_{OV}. In the state described, the switch S is open and substantially no current flows.

In the case of photon capture, in the equivalent circuit diagram the switch S closes and so the current pulse caused by the charge carrier avalanche generated results in a discharge of the diode capacitance C_{D} via the series resistance R_{S}, with the consequence that the voltage proceeding from V_{BIAS} falls back to the breakdown voltage V_{BD}. This is referred to as discharge mode (discharge phase). As described in the introduction, the quench resistance R_{Q} then becomes apparent by virtue of the voltage across the diode being quenched, as a result of which the switch S opens again.

In the phase that follows, referred to as recharge mode (recovery phase), the diode capacitance C_{D} is recharged via the quench resistance R_{Q}, and so a new cycle begins. The sequence is illustrated schematically in FIG. 5, in which a current-voltage characteristic curve is plotted.

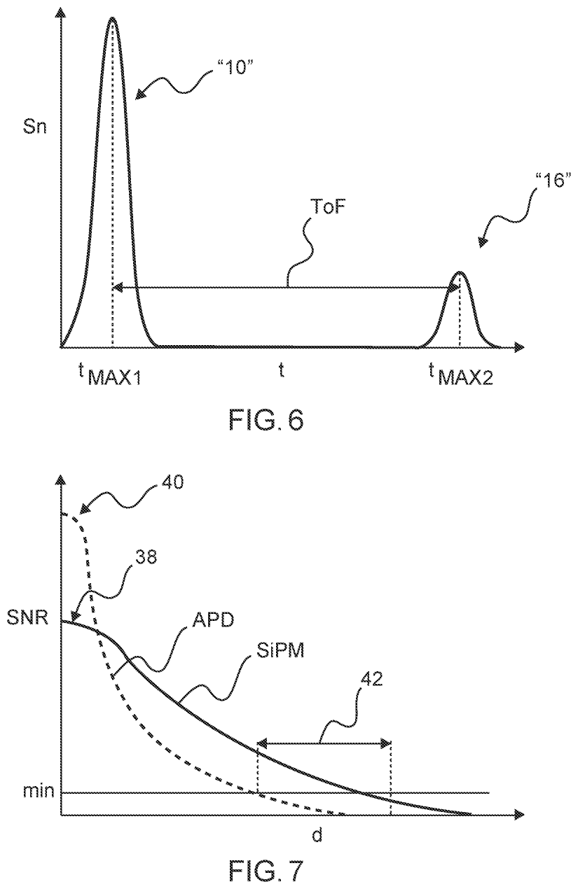

FIG. 6 shows in a schematic diagram the principle of time of flight determination. A pulse signal Sn produced in the laser source 10 or a pulse signal response “ampl” detected in the detector 16 is plotted against the time axis t, coordinated with one another in the control device 20 (see FIG. 1 or 2). Maxima can be ascertained for the output pulse in the laser source 10 and also for the pulse response in the detector 16, which maxima are used as time marks t_{MAX1} and t_{MAX2}, respectively, for the measurement. The temporal difference between the two time marks t_{MAX1} and t_{MAX2}yields the light time of flight ToF. It goes without saying that the respective pulse widths (i.e. pulse durations) impose a limit for the measurement, in particular for the resolution or accuracy of the distances d determined.

FIG. 7 shows a schematic comparison between SiPM sensors (solid line) and conventional APD sensors (dashed line) with regard to the respective signal-to-noise ratio SNR plotted against the distance d over which light signal pulses were transmitted (via the object surfaces 14) to the detectors 16. The SNR level “min” indicates that range (below the relevant line) in which the quality of the signal ampl is no longer sufficient to determine a distance, or to determine a distance including assigned reflectivity. The SNR curve in the case of SiPM sensors from short distances clearly visibly has a pronounced saturation region 38, which has the effect that the SNR ratio in the case of APD sensors (with less pronounced saturation region 40 there) is significantly better in the case of these distances. Outside this saturation region 38, however, the SNR ratio of SiPM sensors, as has been found by the inventors, is clearly superior to that of the APD sensors, in particular toward large distances d, which is why this alone already makes it possible to extend the range for the distance determination (see arrow 42 in FIG. 7) .

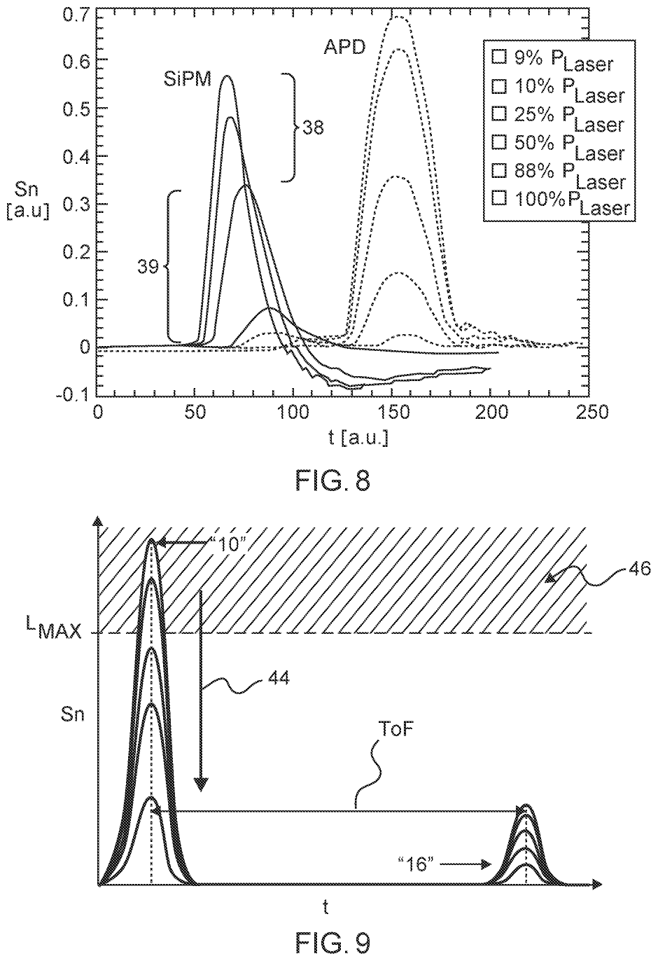

FIG. 8 shows a schematic comparison of the pulse responses plotted against time between SiPM and APD sensors as detectors 16 for six different power levels of the output signal in the laser source 10 (9, 10, 25, 50, 88, 100% of the possible power), the pulse responses between the sensor types being intentionally time-shifted relative to one another for the comparison. The diagram illustrates the pronounced saturation at high radiation powers in the laser source 10 in the case of SiPM sensors as detectors 16. APD sensors, by contrast, exhibit a largely linear relationship. It is furthermore evident that for low radiation powers (or correspondingly for large distances) of the laser source 10, SiPM sensors exhibit a systematic time shift that can be of the order of magnitude of the typical pulse width.

In order then in view of the substantive matter shown in FIGS. 7 and 8, in the case of SiPM sensors, to obtain an improved signal-to-noise ratio for short and also for large distances, it is then possible, in accordance with the exemplary embodiment of the method according to the invention, depending on the distance d, to adapt substantially two parameters: the power of the laser source 10 and the gain factor (gain) of the detector 16 or the SiPM sensor.

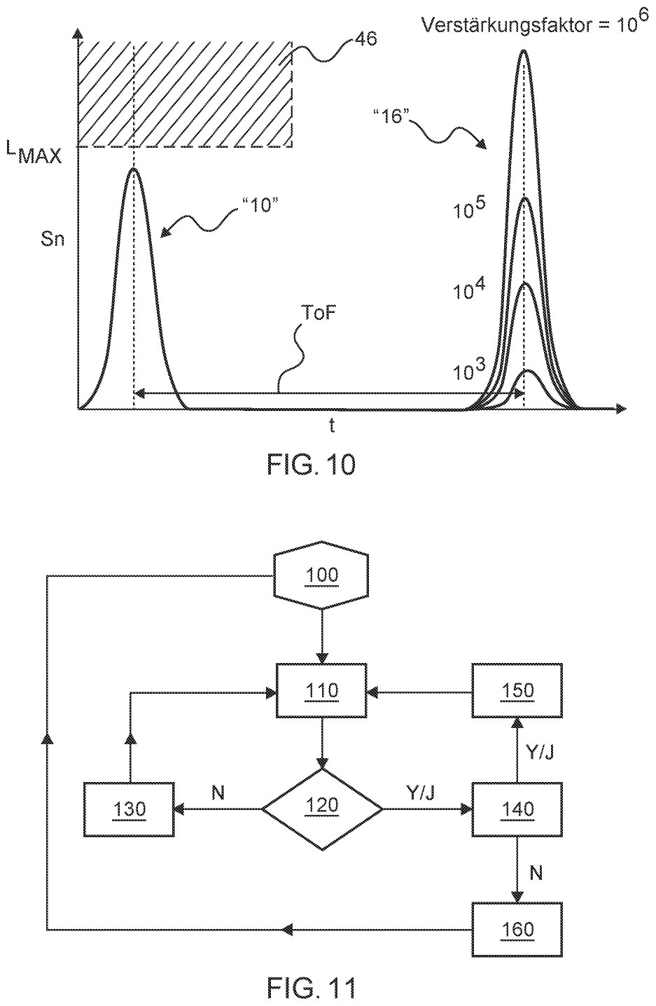

FIGS. 9 and 10 show analogously to FIG. 6 for an SiPM sensor schematically the boundary conditions to be complied with here by virtue of laser safety standards. FIG. 9 illustrates for the parameter of the laser power the case of a large distance d, in the case of which the pulse response of the detector 16 proves to be very weak precisely because of this. The figure shows five power levels of the laser source and correspondingly five signal responses on the part of the detector 16. An increase—taking account of the large distance—of the amplitude of the signal Sn of the laser power is at odds with an upper power limit L_{MAX}, which results from those safety standards (which are intended to protect the human eye, for example) and, in the schematic diagram in FIG. 9, represents an exclusion region 46 to be taken into account in accordance with the exemplary embodiment.

In the case of short distances d (not discernible from FIG. 9), by contrast, a decrease of the laser power is advantageous because the saturation region 38 is left. Since the inherently greater noise in the saturation region 38 (excess shot noise) is avoided here despite a decreased power and thus a decreased signal response, the signal-to-noise ratio SNR can still assume very satisfactory values as a result.

In accordance with the exemplary embodiment, therefore, on the basis of a distance that has already been determined, depending on the latter, an increase of the value of the laser power set can be carried out if the distance is large, or can be decreased if the distance is small. Developments of this exemplary embodiment provide for performing a dynamic real-time adaptation depending on the distance respectively determined. A corresponding exemplary embodiment is explained further below.

FIG. 10 equally illustrates the case of a large distance d for the parameter of the gain factor (gain). Here, too, the exclusion region 46 with regard to the laser power is present, but the parameter adaptation, i.e. an adaptation of the value for the gain factor, is effected on the part of the detector 16, rather than the laser source 10, such that the adaptation of the parameter is not restricted by this condition in any case, as shown schematically by FIG. 10.

In the case of large distances d, in accordance with this exemplary embodiment, provision is made for increasing the gain factor (gain) in order to improve the signal-to-noise ratio and in particular also in order to keep the SiPM sensor in its dynamic region (see below for more details in this respect). By contrast, in the case of small distances, provision is made for decreasing the gain factor—likewise in order to keep the SiPM sensor in the dynamic region.

FIG. 11 shows in a flow diagram the schematic sequence of the method in accordance with this exemplary embodiment. In a step 100, in a LiDAR device 1, 1′ as shown in FIG. 1 or 2, for example, a predetermined first value for the power of the laser source 10 and a predetermined second value for the gain factor (gain) of the detector 16 (SiPM sensor) are predefined (in the case of FIG. 2: the detectors 16 in the SiPM sensor array 24).

In a subsequent step 110, the laser source 10 and the detector 16 are set accordingly and a pulse is generated in the laser source 10, in the case of which pulse light having the predetermined first value of the power is emitted, wherein the detector 16, depending on the irradiance of the reflected or backscattered light detected, outputs a first voltage signal using the predetermined second value for the gain factor.

In a subsequent step 120, a (then first) distance determination is carried out, that is to say that a check is made to establish whether a distance determination is possible at all, and if so (Y in step 120), a first absolute value for the distance d of the object surface 14 is ascertained from a measured light time of flight ToF assigned to the first voltage signal.

If the distance determination is not possible (N in step 120), because the voltage signal assumes a signal-to-noise ratio SNR below a predefined minimum value, the parameters: power of the laser source 10 and/or the gain factor of the detector 16 are adapted, i.e. here increased, in a step 130.

By contrast, if the distance determination was possible and yields the first absolute value for the distance (Y in step 120), a further step 140 involves checking whether the first voltage signal output is in the saturation region 38, i.e. not in the dynamic region 39 (see FIG. 8). For this purpose, a first, upper voltage limit value for a voltage is predefined, below which value (dynamic region 39) for the detector 16 there is a substantially linear relationship between the irradiance of the incident light 18 and a voltage output as a consequence thereof, and above which value the relationship is nonlinear and/or saturated (saturation region 38). Furthermore, in this step, an amplitude of the first voltage signal output by the detector 16 is determined and is compared with the voltage limit value.

If the voltage limit value is exceeded (Y in step 140), then the method continues to step 150. In step 150, the parameters: power of the laser source 10 and/or the gain factor of the detector 16 are adapted, i.e. here: decreased.

In both cases, step 130, in which the distance d is too large to yield a usable voltage signal with a sufficient signal-to-noise ratio SNR, and steps 140, 150, in which the distance d is so small or the power of the radiation source is so high that the SiPM sensor operates in the saturation region 38, one or both parameters is or are adapted dynamically in order to start a second pass.

This is effected recursively returning to step 110, in which the laser source 10 and the detector 16 are again set accordingly or then adapted. That is to say that a pulse is generated again in the laser source 10, in the case of which pulse light having the now possibly adapted first value of the power is emitted, wherein the detector 16, depending on the irradiance of the reflected or backscattered light detected, then outputs a second voltage signal, which is ideally different than the first voltage signal, using the possibly adapted second value for the gain factor, which is then usable and is not in the saturation region 38.

Overall, therefore, in steps 130, 110 and 150, 110, respectively, the first value of the power of the laser source and/or the second value of the gain factor of the detector 16 are/is adapted (decreased or increased in accordance with the above explanations with reference to FIGS. 9 and 10) depending on the determined first absolute value for the distance. In the unusable case (step 130), the determined distance d is not set or is more than a limit value determined in advance, or in the case of the saturation region 38, the determined distance is less than a limit value determined in advance (as becomes evident from FIG. 7).

After once again emitting light by means of the laser source 10 and detecting the reflected or backscattered light by means of the detector 16 and outputting a corresponding second voltage signal using the adapted first and/or second value, it is possible, finally, after repeating steps 110, 120, 140, to determine a second absolute value for the distance of the object surface from a measured light time of flight ToF assigned to the second voltage signal.

Said second absolute value should undergo the corresponding checks in steps 120, 140 in each case with a positive result (Y), after which the method in accordance with this first exemplary embodiment advances to step 160. Here the reflectivity of the relevant object surface 14 is calculated from the second voltage signal. Since the case of the dynamic region 39 is present here, with the indications of the distance d, the first value of the radiation power of the laser source 10, the gain factor (gain) of the detector 16 and the amplitude of the second voltage signal—optionally with suitable calibration—this value for the albedo can be calculated in a processor-aided manner by means of the central control unit 20 in step 160.

In order to determine the distance and reflectivity of a next object surface, the method returns to step 100. In this way, the surroundings of the device can be scanned step by step and a three-dimensional image can be generated as a result. This image can be evaluated by means of object-detecting software in order for example to recognize specific objects, persons or traffic signs etc. and, if appropriate, to take measures.

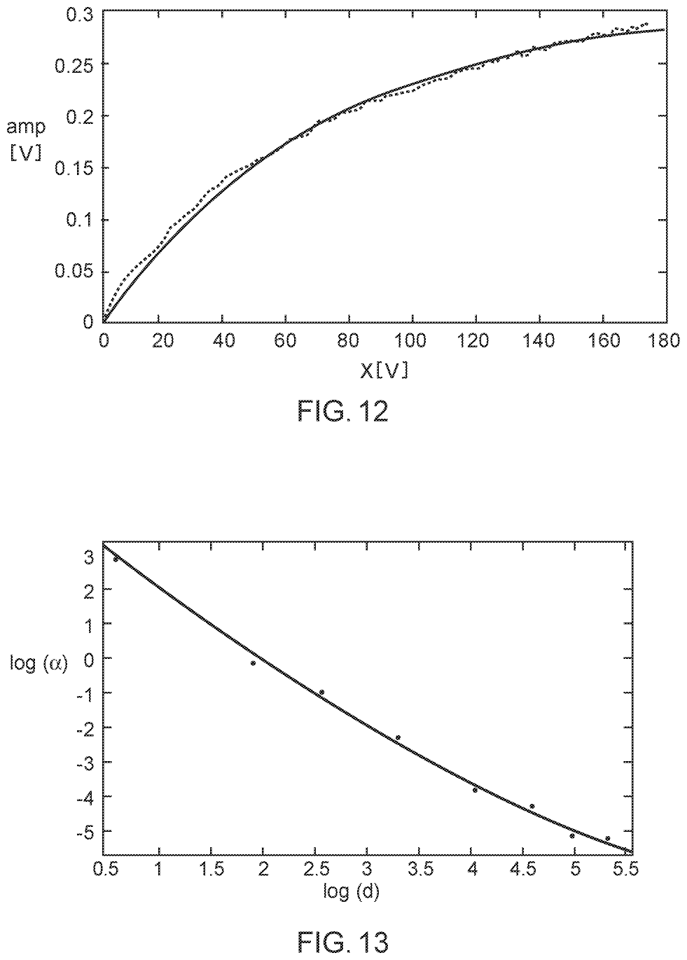

A second exemplary embodiment is shown in FIGS. 12 and 13. The focus here is on determining the reflectivity with the distance already having been determined. FIG. 12 shows for an SiPM sensor the relationship between the amplitude of a voltage signal respectively output and the overvoltage V_{OV} of the detector 16 or a variable x derived from the driver voltage of the laser source 10 with a linear relationship. The dots in the diagram each correspond to a measurement in an exemplary device 1 as shown in FIG. 1, for instance.

The relationship corresponds to a function

amp=c1·(1−exp(−(c2·x)/c1)), (1)

which yields a very good fit, wherein the amplitude amp of the voltage signal is yielded by the SiPM sensor and x is related to the driver voltage V1 of the laser source 10 by:

x=(V1−2.5)/0.5. (2)

The coefficients c1 and c2 are determined by the fit. In the very specific exemplary embodiment, the coefficients are c1=0.3015 and c2=0.004296. The fit is indicated by a solid line in FIG. 12. What is discernible very well is a relatively linear relationship up to an amplitude of approximately 0.18 V, which here is the dynamic region 39, wherein above 0.18 V there follows a nonlinear saturation region (up to the asymptotic limit value at approximately 0.55 V in this specific, non-limiting example).

This second exemplary embodiment then provides for performing a linearization of the curve shown. For this purpose, equation (1) for the nonlinear amplitude response amp is transformed according to the linearized amplitude response y_{act}:

y_{act}=x=−log(1−amp/c1)·c1/c2, (3)

The measured amplitudes of the measurements for various (known) distances with differing laser power (in accordance with x) can then be inserted in equation (3) and yield in each case straight lines having a gradient a dependent on the distance d:

y_{ref}=α(d)·x (4)

In order to determine α(d), it is possible once again to use a fit, for example, wherein a transformation into the logarithmic scale was carried out here as well:

log(α)=k1·log(d)²+k2·log(d)+k3 (5)

The exemplary fit is only up to the 2^{nd} order, but without limitation could also be of a higher order. FIG. 13 shows however for the measurement points that the fit is sufficient. In FIG. 13, log(α) is plotted as a function of log (d), wherein d is the distance. The coefficients ascertained for this specific example read: k1=0.118; k2=−2.438; k=4.305.

The following arises for the thus empirical, linearized reference amplitude:

y_{ref}exp(k1·log(d)2+k2·log(d)+k3)·x. (6)

In the second exemplary embodiment, therefore, the linearized reference amplitude y_{ref} can be immediately calculated as a reference value from equation (6), given a distance d determined by light time of flight measurement. On the other hand, the actual, linearized amplitude response y_{act} can be directly measured or determined anew. Since the distance d is the same in both cases (after all, the distance is obtained from the same voltage signal), a difference between the two variables y_{act} and y_{ref} is based exclusively on a difference in the underlying reflectivity or albedo. The albedo can be calculated from the quotient of y_{act} and y_{ref}:

albendo=albedo_{ref}·(y_{act}/y_{ref})^{1/2}, (7)

wherein albedo_{ref} is the albedo of a reference material used to carry out the fit. Ideally the reference material is a material with a particularly high albedo, for example aluminum with albedo_{ref}=0.88. Conversely, however, it is also possible to use other materials with a lower albedo as reference, such as e.g. steel with albedo_{ref}=0.68 or titanium with albedo_{ref}=0.34, etc. These method steps allow a particularly efficient and fast calculation of the reflectivity, which is necessary to achieve rapid updating of the detected surroundings.

The steps of the second exemplary embodiment can be carried out in the context of step 160 of the first exemplary embodiment, or else in the context of step 290 of the third exemplary embodiment described below:

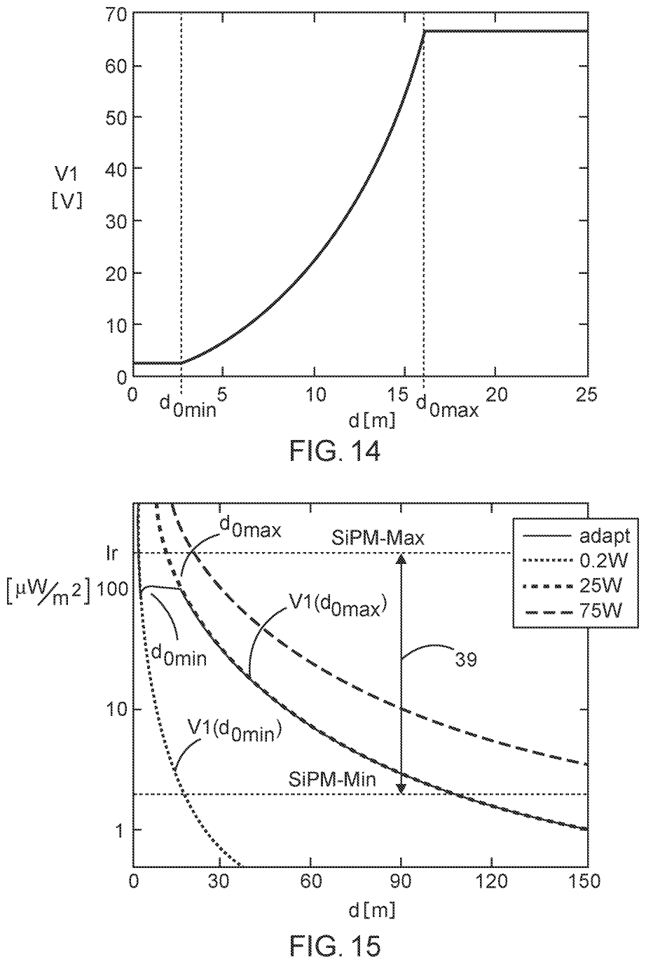

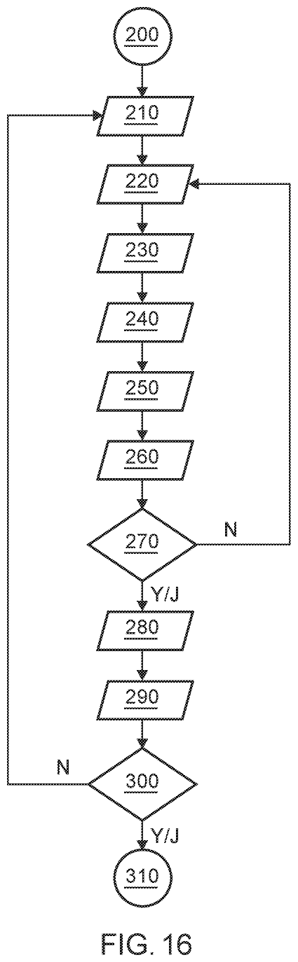

In this regard, reference is made to FIGS. 14-16. FIG. 16 shows in a flow diagram the sequence of the method in accordance with the third exemplary embodiment. After the start 200 of the method sequence, firstly a maximum distance dₘₐₓ (as start value) is predefined in step 210. Afterward, in step 220, a driver voltage V1 (d) is sought for this start value, the laser source 10 being operated with said driver voltage in order to emit light having a power that is sufficient to operate the detector 16 in the dynamic region 39.

In this example, too, for this purpose a function V1 (d) simplifying the calculation is again predefined, this function being shown in FIG. 14. The aim here is, by adapting the driver voltage V1 of the laser source 10, to maintain an irradiance in the detector 16 always approximately in the center of the dynamic region 39 independently of the distance d. The dynamic region 39 is determined by an upper limit value and a lower limit value for the irradiance, which respectively correspond to an upper and lower voltage limit value for the voltage output. The upper limit value is determined by the incipient saturation as described. The lower limit value is determined by a minimum signal-to-noise ratio SNR that is usable and permissible for the detection, which is defined here as 10 dB. In one specific example, the lower limit value SiPM-MIN is approximately 2 μW/m² and the upper limit value SiPM-MAX is approximately 200 μW/m², such that the dynamic region still constitutes 20 dB.

A fit becomes necessary since although the power of the laser source 10 is proportional to the square of the distance d, and although the driver voltage is also related linearly to the power, a laser power is brought about only starting from a certain start value. A 3^{rd} order polynomial fit has proved itself here:

V(P(d))=e·P(d)³+f·P(d)²+g·P(d)+h. (8)

In the specific example, the coefficients were determined as follows: e=0.000793; f=−0.005521; g=2.276; h=0.8674. The curve, which is substantially parabolic nevertheless, is shown in FIG. 14. In the case of the distance d₀ₘᵢₙ, a minimum possible power for the laser source 10 is present, in the specific example 0.2 W. For distances d below this limit value, step 220 of the method in this specific third exemplary embodiment always returns the same value of magnitude 1.5 volts for the driver voltage V1. Likewise, for all distances d above a limit value d₀ₘₐₓ, which corresponds to a maximum power—predefined in accordance with the safety standards—of 25 W in this example, only the value of 66.5 volts is returned for the driver voltage V1. In the example, exactly this upper limit value d₀ₘₐₓ was taken as start value. The (first) value of the power of the laser source 10 is then set in step 220. The gain factor or gain is not varied in this exemplary embodiment.

The laser source 10 is triggered in step 230 and, as a consequence thereof, a light pulse is generated in step 240. The light 18 reflected or backscattered from the object surface is received or detected by the detector 16 in step 250. In step 260. the first value for the distance, designated here as D, can be determined from the (first) voltage signal obtained. Step 270 involves checking whether d=D, i.e. whether the first value for the distance is equal to the distance predefined as start value. If this is not the case (N in step 270), the program sequence branches back to step 220. A new driver voltage V1 is sought here in accordance with the function in FIG. 14 or equation (8).

As is shown in FIG. 15, the parabolic portion shown in FIG. 14 corresponds to a flat portion of the irradiance Ir as a function of the distance. The target value in the center of the dynamic region between SiPM-MAX and SiPM-MIN is 100 μW/m². As long as the distance d is between d₀ₘᵢₙ and d₀ₘₐₓ, this median value in the dynamic region 39 is maintained again and again. The distances d₀ₘᵢₙ and d₀ₘₐₓ are 3 and 16 m in the example. Above d₀ₘₐₓ, a fixed value of V1 (d) is returned, and so the irradiance Ir decreases, but evidently still up to a range of approximately 115 m is sufficient to lie above the lower limit SiPM-MIN, that is to say in the dynamic region 39.

On the other hand, correspondingly below d₀ₘᵢₙ likewise only constant values for V1 (d) are returned. The latter only up to approximately 2 m result in irradiances that lie below the upper limit SiPM-MAX of the dynamic region.

The discrepancy between d and D in step 270 thus arises if the actual distance in FIG. 15 is less than d₀ₘₐₓ and V1 (d₀ₘₐₓ) is returned at the start of the program. The dashed curve in FIG. 15 reproduces this value for Vl. In the subsequent second pass, then the correct value for the driver voltage V1 is found and, following therefrom, the correct distance d=D is found in step 270.

Then as described above in the second exemplary embodiment, the amplitude amp is determined in step 280 (Y in step 270) and the albedo value is calculated in step 290. Step 300 involves checking whether further pixels are to be detected and, if that is applicable (Y in step 300), the program branches back to step 210. Otherwise, the program sequence ends (step 310).

It should be noted that in this third exemplary embodiment the laser power is not adapted only when the upper voltage limit or upper limit SiPM-MAX of the dynamic region 39 is exceeded, but rather is already adapted if any change at all vis-à-vis the preset distance is established.

### LIST OF REFERENCE SIGNS:

1, 1′ Device
10 Laser source
12 Laser light beam
14 Object surface
16 Detector, silicon photomultiplier (SiPM sensor)
18 Reflected or backscattered light
20 Central control device
22 Light time of flight (ToF)
24 Detector array (SiPMs)
26 Lens optical unit
28 MEMS
30 Micromirror
32 Direction of rotation of the micromirror/light beam
34 Diffuser
36 Microcell (SiPM)
38 Saturation region (SiPM)
40 Saturation region (APD) (comparative example)
42 Increase of range by SiPM
44 Decrease of the radiation power owing to safety standard
46 Exclusion region
C_{D} Diode capacitance
L_{MAX} Maximum permissible radiation power (laser)
R_{Q} Quench resistance
R_{S} Series resistance (Si substrate)
S Switch (equivalent circuit diagram)
100 Predefining a first value for the power of the laser source and a second value for the gain of the detector
110 Setting the laser source and the detector, generating a pulse in the laser source, and detecting the pulse in the detector in accordance with the predefined values for outputting a voltage signal
120 Carrying out a distance determination or checking whether a distance determination is possible
130 Adapting the values for power of the laser source and/or gain of the detector
140 Checking whether the first voltage signal output is in the saturation region, i.e. not in the dynamic region
150 Adapting the values for power of the laser source and/or gain of the detector
160 Calculating the reflectivity of the relevant object surface from the second voltage signal
200 Start of the method sequence, providing the laser source, detector and object surface
210 Predefining a start value for the distance d (e.g. max. distance dₘₐₓ)
220 Seeking a value for the driver voltage V1 (d) with which the laser source is operated (adapting and/or setting a value for the power of the laser source)
230 Triggering the laser source
240 Generating a light pulse
250 Detecting the light reflected or backscattered from the object surface by means of the detector and outputting a voltage signal
260 Determining the distance D from the voltage signal output
270 Checking whether d=D (i.e. whether the determined distance is equal to the distance predefined as start value)
280 Determining the amplitude ampl
290 Calculating the albedo value
300 Checking whether further pixels are to be detected
310 End of the method sequence

1. A method for determining a distance and reflectivity of an object surface (14) using a laser source (10) that emits light (12) having a power, and using a detector (16) that detects the light (18) reflected or backscattered from the object surface (14) and having an irradiance and depending thereon outputs a time-dependent voltage signal, comprising:
setting (100, 110, 220, 230, 240) the laser source, such that the latter emits light having a predetermined first value of the power in at least one pulse,
setting (100, 110) the detector, such that the latter outputs a first voltage signal having a predetermined second value for a gain factor depending on the irradiance of the reflected or backscattered light detected,
determining (120, 260) a first absolute value for the distance of the object surface from a measured light time of flight assigned to the first voltage signal,
adapting (130, 150, 220) the first value of the power of the laser source and/or the second value of the gain factor of the detector depending on the determined first absolute value for the distance,
once again emitting (110, 240) light by means of the laser source (10) and detecting (110) the reflected or backscattered light (18) by means of the detector (16) and outputting (110) a corresponding second voltage signal using the adapted first and/or second value,
determining (120, 260) a second absolute value for the distance (d) of the object surface (14) from a measured light time of flight (ToF) assigned to the second voltage signal.

2. The method as claimed in claim 1, wherein
a silicon photomultiplier (SiPM) is provided as detector (16).

3. The method as claimed in claim 1 or 2, wherein
a laser that operates in the near infrared spectral range, preferably in the range of wavelengths of 840 nm to 1550 nm, is provided as laser source (10).

4. The method as claimed in any of claims 1 to 3, wherein
the steps of the method are carried out repeatedly for individual pixels in the context of a LiDAR application in the field of driver assistance systems or systems for autonomous driving for scanning various object surfaces (14) of surroundings of a vehicle for the computer-aided construction of a three-dimensional image of the surroundings.

5. The method as claimed in any of claims 1 to 4, furthermore comprising:
predefining a first, upper voltage limit value (SiPM-MAX) for a voltage, below which value (39) for the detector (16) there is a substantially linear relationship between the irradiance of the incident light (18) and a voltage output as a consequence thereof, and above which value (38) the relationship is nonlinear and/or saturated,
determining an amplitude (ampl) of the first output signal, comparing (140) the amplitude (ampl) with the voltage limit value (SiPM-MAX),
wherein in the step of adapting (150) the first value of the power of the laser source (10) and/or the second value of the gain factor of the detector (16), the extent of the adaptation is carried out depending on the result of the comparison (140).

6. The method as claimed in claim 5, wherein if the amplitude (ampl) exceeds the voltage limit value (SiPM-MAX), the adaptation includes a decrease of the first and/or
second value, such that in the subsequent step (110) the irradiance of the incident light (12) is reduced in the detector (16) and as a consequence thereof an amplitude (ampl) of the second voltage signal falls below the predefined first voltage limit value (SiPM-MAX).

7. The method as claimed in claim 6, wherein the decrease includes a reduction of the first and/or second value by 50% or more.

8. The method as claimed in any of claims 1 to 7, comprising predefining a second, lower voltage limit value (SiPM_MIN) for a voltage, which value ensures a predefined signal-to-noise ratio, preferably 2 dB or more, more preferably approximately 10 dB or more, for the detector (16),
determining an amplitude of the first output signal, comparing the amplitude with the second voltage limit value (SiPM-MIN),
wherein the step of adapting (150) the first value of the power of the laser source and/or the second value of the gain factor of the detector includes an increase of the first and/or second value, such that in the subsequent step (110) the irradiance of the incident light (12) is reduced in the detector (16) and as a consequence thereof an amplitude of the second voltage signal lies above the predefined second voltage limit value (SiPM-MIN).

9. The method as claimed in any of claims 1 to 8, wherein provision is made of a function (V1 (d)) between the power of the laser source (10) and the distance (d) of the object surface (14) for a fixedly selected irradiance of the detector (16) in relation to the reflected and/or backscattered light (18),
wherein the first value of the power predetermined for the adaptation (220) and/or the predetermined second value for the gain factor are/is ascertained with the argument of the first absolute value for the distance determined from the first voltage signal and the adaptation is carried out according to this function.

10. The method as claimed in claim 9, wherein
before the step of the first setting (220) of the power of the laser and/or the gain factor of the detector, a start value (d₀ₘₐₓ) for the absolute value of the distance is predefined (210), and in a subsequent step (220), the power and/or the gain factor are/is ascertained from the predefined function, on the basis of which the laser source (10) and/or the detector (16) can subsequently be set.

11. The method as claimed in claim 9 or 10, wherein
a lower power limit and an upper power limit are defined for the predefined function between the power of the laser source (10) and the distance (d) of the object surface (14),
wherein for all distances (d<d₀ₘᵢₙ) below the distance (d₀ₘᵢₙ) assigned to the lower power limit, only the value of the lower power limit is returned and used, and
wherein for all distances (d>d₀ₘₐₓ) above the distance (d₀ₘₐₓ) assigned to the upper power limit, only the value of the upper power limit is returned and used.

12. The method as claimed in claim 11, wherein
the lower power limit is set in accordance with a minimum output power of the laser source, and/or
the upper power limit is set either in accordance with a safety standard of the laser source or in accordance with a physical power limit of the laser source, depending on which value is lower.

13. The method as claimed in any of claims 1 to 12, wherein
after the step of determining (120, 260) the second absolute value for the distance (d) of the object surface (14) from a measured light time of flight (ToF) assigned to the second voltage signal, a further step of determining (160) a reflectivity of the object surface (14) on the basis of the second voltage signal and the determined first and/or second value for the distance (d) is carried out.

14. The method as claimed in claim 13, wherein
a second function (y_{act}) is provided, which indicates a linearized response to an amplitude of the second voltage signal, having the form:
y_{act}=−log(1−amp/c1)·c1/c2,
wherein amp corresponds to the amplitude of the second voltage signal, and c1, c2 are coefficients determined from measurements by means of a mathematical fit, and
a third function (y_{ref}) is provided, which indicates a linearized reference response to an amplitude of the second voltage signal as a function of a distance of the object surface and a power of the laser source (10), having the form:
y_{ref}=α(d)·x,
wherein x corresponds to the power of the laser source and a is a linear gradient factor that is dependent on the distance (d) and is determined from measurements by means of a mathematical fit,
wherein the linearized response (y_{act}) is calculated from the amplitude of the second voltage signal determined by measurement,
wherein the linearized reference variable (y_{ref}) is calculated from the ascertained second value for the distance (d) and the set power of the laser source (10), and
wherein the reflectivity is calculated from a quotient of the linearized response y_{act} and the linearized reference variable y_{ref}.

15. A device (1) for determining a distance (d) and reflectivity of an object surface (14), comprising:
a laser source (10) that emits light (12) having a power,
a detector (16) that detects the light (18) reflected or backscattered from the object surface (14) and having an irradiance and depending thereon outputs a time-dependent voltage signal,
a control device (20) configured to carry out the method having the steps as claimed in any of claims 1 to 14.
